(19) United States
(12) Patent Application Publication
(10) Pub. No.: US 2026/0260557 A1
(43) Pub. Date: Sep. 3, 2026

(54) TAMPER-PROOF MOUNTING STRAP FOR A MONITORING DEVICE

(71) Applicant: Alcohol Monitoring Systems, Inc., Littleton, CO (US)

(72) Inventors: Anne Baker Oram, Lakewood, CO (US); Kyle Patrick Glavan, Castle Rock, CO (US); Raymond Anthony Sirianne, Evergreen, CO (US)

(21) Appl. No.: 18/878,425

(22) PCT Filed: Jun. 27, 2023
(86) PCT No.: PCT/US2023/069153

§ 371 Date: Dec. 23, 2024

Related U.S. Application Data
(60) Provisional application No. 63/355,802, filed on Jun. 27, 2022.

(51) Int. Cl. G08B 21/22; A44B 11/22

(52) U.S. Cl. CPC G08B 21/22; A44B 11/22

(57) ABSTRACT

A tamper-proof mounting strap is used to secure a monitoring device to a part of a person. The mounting strap includes a first strap half and a second strap half molded together with each strap half extending between an attachment end of the mounting strap and a terminal end of the mounting strap to define an elongate length of the mounting strap. The mounting strap is affixed to the housing of the monitoring device with the attachment end of the mounting strap. A continuity element and a multi-body cut resistant member are located between the first strap half and the second strap half.

### CROSS-REFERENCE TO RELATED APPLICATION

This application claims the benefit of U.S. Provisional Application Ser. No. 63/355,802 filed on Jun. 27, 2022, the disclosure of which is hereby incorporated by reference in its entirety.

### TECHNICAL FIELD

This invention relates generally to wearable tracking and monitoring devices and, more particularly, to a tamper-proof mounting strap for such devices.

### BACKGROUND

Monitoring and tracking technologies, such as the SCRAM Global Positioning System (SCRAM GPS®) and the SCRAM Continuous Alcohol Monitoring (SCRAM CAM), commercially available from the Assignee of the present disclosure, are used to monitor certain biometrics of people, such as alcohol consumption, and their locations while they await trial, or if they are on house arrest, parole, or probation, for example. Such tracking devices, otherwise referred to as monitoring devices, ankle bracelets, ankle monitors, or ankle tags, are often strapped to a person's ankle to monitor and track the individual.

A problem with existing tracking and monitoring devices is that the mounting strap used to secure the device to a person's ankle, for example, can be broken or cut with minimal effort. Once the device is removed, the person previously wearing the device may flee or otherwise avoid being monitored or tracked for a period of time before enforcement authorities can respond. Accordingly, a need exists to provide a tamper proof, cut resistant mounting strap for securing a tracking/monitoring device to a person.

### SUMMARY

The present invention overcomes the foregoing and other shortcomings and drawbacks of mounting straps used to secure a monitoring device to a person. While the present invention will be discussed in connection with certain embodiments, it will be understood that the present invention is not limited to the specific embodiments described herein.

According to one embodiment of the invention, at least one mounting strap for securing a monitoring device to a part of a person is provided. The monitoring device includes a housing containing components of the monitoring device and a locking mechanism configured to engage the mounting strap. The at least one mounting strap includes a first strap half and a second strap half, each strap half extending between an attachment end of the at least one mounting strap and a terminal end of the at least one mounting strap to define an elongate length of the at least one mounting strap. A continuity element is located between the first strap half and the second strap half and at least one cut resistant member is located between the first strap half and the second strap half. To this end, the at least one mounting strap is affixed to the housing of the monitoring device with the attachment end of the at least one mounting strap.

According to one aspect of the invention, the at least one cut resistant member comprises a first cut resistant member and a second cut resistant member. According to another aspect, the first strap half includes a first channel configured to receive the first cut resistant member and a second channel configured to receive the second cut resistant member therein. According to yet another aspect, the first channel and the second channel extend in parallel from the attachment end of the at least one mounting strap to the terminal end of the at least one mounting strap. According to another aspect, the first channel includes a plurality of pegs configured to maintain a position of the first cut resistant member therein and the second channel includes a plurality of pegs configured to maintain a position of the second cut resistant member therein.

According to one aspect of the invention, the first strap half includes a track configured to receive the continuity element therein. According to another aspect, the track includes a first elongate portion and a second elongate portion that extend in parallel from the attachment end of the at least one mounting strap to U-shaped base portion at the terminal end of the at least one mounting strap. According to yet another aspect, the first elongate portion of the track communicates with a first bore formed in the first strap half at the attachment end and the second elongate portion of the track communicates with a second bore formed in the first strap half at the attachment end. According to one aspect, the track is located between the first channel and the second channel.

According to one aspect of the invention, a first terminal end of the continuity element is routed through the first bore and a second terminal end of the continuity element is routed through the second bore. According to another aspect of the invention, the first strap half includes a first plurality of hold-downs distributed along the length of the at least one mounting strap configured to overlie the first channel and a second plurality of hold-downs distributed along the length of the at least one mounting strap configured to overlie the second channel.

According to another aspect of the present invention, the at least one mounting strap includes a plurality of adjustment holes formed in the first strap half and the second strap half and distributed along the length of the at least one mounting strap, the plurality of adjustment holes configured to receive a portion of the locking mechanism of the monitoring device to selectively couple the terminal end of the at least one mounting strap to the housing.

According to one aspect, the at least one mounting strap includes a ground bracket located between the first strap half and the second strap half at the attachment end of the at least one mounting strap. According to another aspect, the ground bracket is in electrical communication with a pair of fasteners used to affix the at least one mounting strap to the monitoring device.

According to one aspect, the continuity element comprises a fiber optic cord. According to another aspect, the first cut resistant member and the second cut resistant member comprise a chain. According to yet another aspect, the first cut resistant member and the second cut resistant member comprise a Cuban chain. According one aspect, the at least one cut resistant member comprises at least one multi-body cut resistant member. According to another aspect, the first strap half and the second strap half are formed together as a unitary piece.

According to another embodiment of the present invention, a monitoring device having a housing enclosing electronic components of the monitoring device, a locking mechanism, and at least one mounting strap is provided. The at least one mounting strap extends from an attachment end that is affixed to the housing and a terminal end configured to be selectively coupled to the housing of the monitoring device with the locking mechanism. The at least one mounting strap includes a first strap half and a second strap half, each strap half extending between the attachment end of the at least one mounting strap and the terminal end of the at least one mounting strap to define an elongate length of the at least one mounting strap. A continuity element is located between the first strap half and the second strap half and at least one cut resistant member is located between the first strap half and the second strap half.

According to one aspect of the invention, the first strap half and the second strap half are formed together as a unitary piece. According to another aspect, the at least one cut resistant member comprises a first cut resistant member and a second cut resistant member. According to yet another aspect, the first strap half includes a first channel configured to receive the first cut resistant member and a second channel configured to receive the second cut resistant member therein. According to one aspect, the first channel and the second channel extend in parallel from the attachment end of the at least one mounting strap to the terminal end of the at least one mounting strap. According to yet another aspect, the first channel includes a plurality of pegs configured to maintain a position of the first cut resistant member therein and the second channel includes a plurality of pegs configured to maintain a position of the second cut resistant member therein.

According to one aspect of the invention, the first strap half includes a track configured to receive the continuity element therein. According to another aspect, the track includes a first elongate portion and a second elongate portion that extend in parallel from the attachment end of the at least one mounting strap to U-shaped base portion at the terminal end of the at least one mounting strap. According to yet another aspect, the first elongate portion of the track communicates with a first bore formed in the first strap half at the attachment end and the second elongate portion of the track communicates with a second bore formed in the first strap half at the attachment end. According to one aspect, a first terminal end of the continuity element is routed through the first bore and a second terminal end of the continuity element is routed through the second bore. According to another aspect, the track is located between the first channel and the second channel.

According to one aspect, the first strap half includes a first plurality of hold-downs distributed along the length of the at least one mounting strap configured to overlie the first channel and a second plurality of hold-downs distributed along the length of the at least one mounting strap configured to overlie the second channel.

According to another aspect of the invention, the at least one mounting strap includes a plurality of adjustment holes formed in the first strap half and the second strap half and distributed along the length of the at least one mounting strap, the plurality of adjustment holes configured to receive a portion of the locking mechanism of the monitoring device to selectively couple the terminal end of the at least one mounting strap to the housing.

In yet another aspect, the at least one mounting strap includes a ground bracket located between the first strap half and the second strap half at the attachment end of the at least one mounting strap. According to one aspect, the ground bracket is in electrical communication with a pair of fasteners used to affix the at least one mounting strap to the monitoring device.

According to one aspect, the continuity element comprises a fiber optic cord. According to another aspect, the first cut resistant member and the second cut resistant member comprise a chain. According to yet another aspect, the first cut resistant member and the second cut resistant member comprise a Cuban chain. According one aspect, the at least one cut resistant member comprises at least one multi-body cut resistant member.

According to yet another aspect, the at least one mounting strap comprises a first strap portion and a second strap portion each separately affixed to the housing of the monitoring device. The first strap portion and the second strap portion are configured to be connected together to secure the monitoring device to a part of a person.

In another embodiment of the invention, a method of manufacturing at least one mounting strap that includes a first strap half and a second strap half, with each strap half extending between an attachment end of the at least one mounting strap and a terminal end of the at least one mounting strap to define an elongate length of the at least one mounting strap is provided. The at least one mounting strap includes a continuity element located between the first strap half and the second strap half and at least one cut resistant member is located between the first strap half and the second strap half. The method includes providing a first mold and disposing a first shot of polymer material therein to form the first strap half from the first shot of polymer material, the first strap half having the first channel, the second channel, and the track formed therein, each of which extend from the attachment end of the at least one mounting strap to the terminal end of the at least one mounting strap. The method further includes providing a second mold and disposing the first strap half in the second mold. The method includes disposing the continuity element within the track and disposing the at least one cut resistant member within the channel. The method includes disposing a second shot of polymer material in the second mold and forming the second strap half over the first strap half such that the first strap half and the second strap half are formed together as a unitary piece.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a perspective view of a mounting strap for securing a monitoring device to a part of a person in accordance with an embodiment of the invention.

FIG. 2 is a front perspective view of the mounting strap of FIG. 1, illustrating coupling of the mounting strap to a housing of the monitoring device with a backplate.

FIG. 3 is a rear perspective partially disassembled view of the mounting strap and monitoring device of FIGS. 1-2.

FIG. 3A is a front perspective view of the mounting strap of FIGS. 1-3.

FIG. 4 is a disassembled perspective view of the mounting strap of FIGS. 1-3.

FIG. 5 is a perspective view of a first strap half of the mounting strap of FIGS. 1-4.

FIG. 6 is a cross-sectional view of the mounting strap of FIG. 5, including a second strap half, taken along line 6-6 of FIG. 5.

FIG. 7A-7C illustrate a method of manufacturing the mounting strap of FIGS. 1-6 in accordance with an embodiment of the invention.

FIG. 8A is a front view of a mounting strap for securing a monitoring device to a part of a person in accordance with another embodiment of the invention.

FIG. 8B illustrates the mounting strap of FIG. 8 fastened around an object to secure the monitoring device to the object.

### DETAILED DESCRIPTION

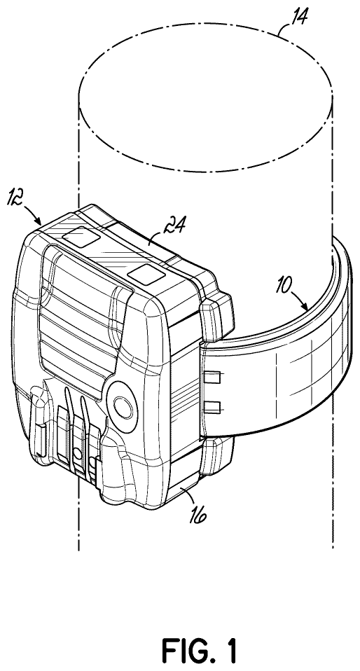

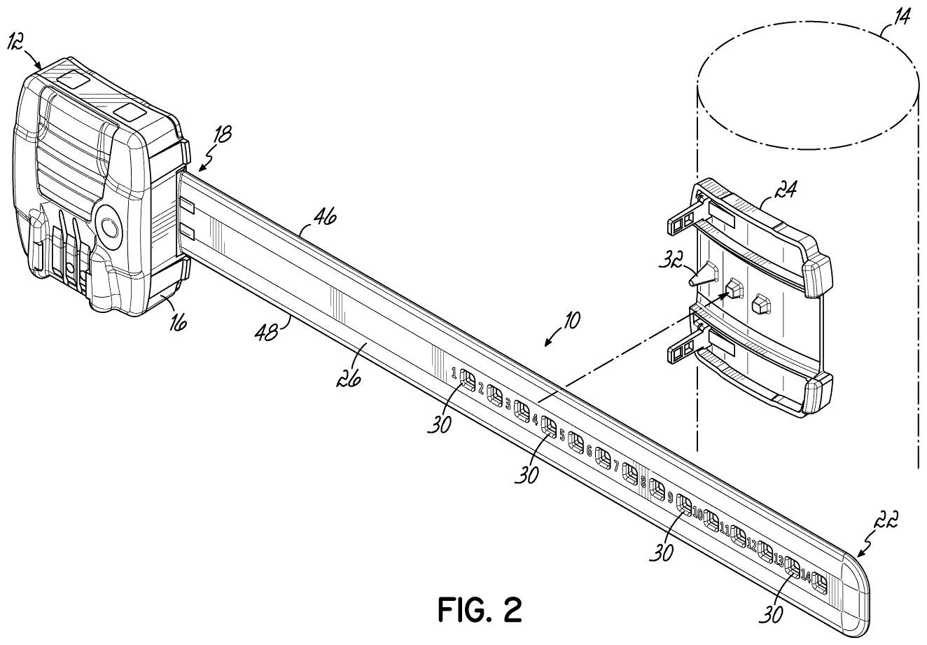

Referring now to the figures, and FIGS. 1-2 in particular, a mounting strap 10 for securing a monitoring device 12 to an object 14, such as a person's ankle or wrist, for example, is shown in accordance with an embodiment of the invention. As shown, the monitoring device 12 includes a housing 16 for containing electronic circuitry and related components to enable the monitoring device 12 to wirelessly communicate and receive information to/from a remote location. The information may include, for example, a location and status information of the monitoring device 12, such as battery life or a status of tamper detection means. The monitoring device 12 may be the SCRAM GPS® ankle monitor bracelet commercially available by the Assignee of the present disclosure. However, while the mounting strap 10 is shown and described in the context of a monitoring device having certain characteristics, it will be understood that the same inventive concepts related to embodiments of the mounting strap 10 may be implemented with different types of monitoring devices, such transdermal alcohol detecting devices like the SCRAM CAM® which is also commercially available from the Assignee of the present disclosure. To this end, the mounting strap 10 may be used with any type of wearable monitoring or tracking device, and the drawings are not intended to be limiting. Further, the term “monitoring device” should not be limited solely to devices intended to be worn by offenders or parolees. Instead, it should be broadly interpreted to encompass any wearable tracking or monitoring device, or combinations thereof, capable of detecting the location and/or status of the wearer or the device itself. Such devices may include a GPS, a substance monitoring unit (such as an alcohol monitor), and/or a Pulse Oximeter. Additionally, this term should encompass tracking devices that can be carried, worn, or used by animals, objects (such as motorized vehicles, bicycles, computing equipment, containers, and other devices), or individuals.

With reference to FIGS. 1-3A, the mounting strap 10 extends from an attachment end 18 configured to be affixed to the housing 16 with fasteners 20 and a terminal end 22 configured to be selectively coupled to the housing 16 of the monitoring device 12 with a locking mechanism in the form of a backplate 24, as described in further detail below. As shown, the attachment end 18 of the mounting strap 10 includes a pair of mounting bores 25 configured to receive a respective fastener 20 (e.g., screws, bolts, or the like) therethrough. However, in an alternative embodiment, the attachment end 18 may include different mounting means, such as a snap fit or press fit interface or the like used to affix the attachment end 18 of the mounting strap 10 to the housing 16. In any event, the mounting strap 10 includes a first elongate strap half 26 and a second elongate strap half 28 molded together to form the mounting strap 10, being a uniform piece. In this regard, the first strap half 26 and the second strap half 28 extend between the attachment end 18 of the mounting strap 10 and the terminal end 22 of the mounting strap 10 to define an elongate length of the mounting strap 10. As described in further detail below, the first strap half 26 and the second strap half 28 are formed of a flexible polymer such as thermoplastic polyurethane, urethane, silicone, rubber, or other similar thermoplastic or thermoset elastomer material, for example. To this end, any suitable material that is flexible when cured may be used. As described in further detail below, the mounting strap 10 may be formed using an overmolding process.

With continued reference to FIGS. 1-3A, the mounting strap 10 includes a plurality of adjustment holes 30 formed in the first strap half 26 and the second strap half 28. The adjustment holes 30 are distributed in a spaced apart arrangement a distance along the length of the mounting strap 10. The adjustment holes 30 may be spaced apart along the axial centerline A1 of the mounting strap 10, for example. The plurality of adjustment holes 30 may extend along the entire length of the mounting strap 10 or a length along the mounting strap 10 measured from the terminal end 22. In either case, the plurality of adjustment holes 30 are configured to receive a locking pin 32 on the backplate 24 to maintain a fit of the mounting strap 10 about the person's ankle or wrist 14, for example, when the terminal end 22 of the mounting strap 10 is coupled to the housing 16 of the monitoring device 12 with the backplate 24, as shown in FIG. 1. To this end, the plurality of adjustment holes 30 may be used to finely adjust the fit of the mounting strap 10 about the person's ankle or wrist 14, for example (i.e., accommodate for different ankle or wrist sizes).

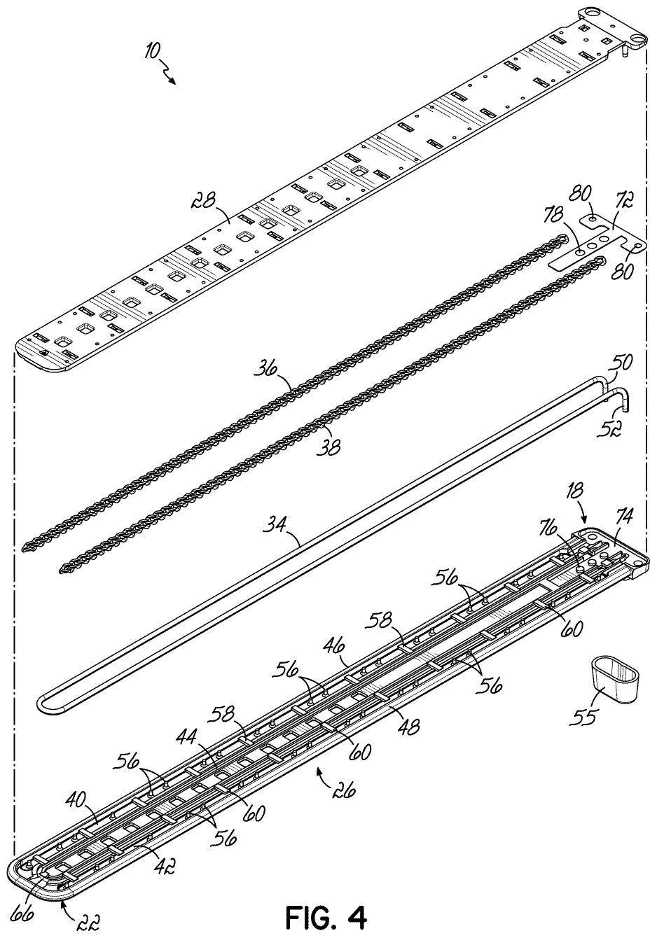

With reference to FIGS. 4-6, the mounting strap 10 includes a continuity element 34 and at least one cut resistant member located between the first strap half 26 and the second strap half 28. In particular, the mounting strap 10 includes a first cut resistant member 36 and a second cut resistant member 38. However, in another embodiment, the mounting strap 10 may include fewer or more cut resistant member(s) 36, 38, such as a single cut resistant member. In any event, the first strap half 26 is formed with a first channel 40 configured to receive the first cut resistant member 36 therein and a second channel 42 configured to receive the second cut resistant member 38 therein. The first strap half 26 is also formed with a generally U-shaped track 44 configured to receive the continuity element 34 therein. The first channel 40 and the second channel 42 extend in parallel from the attachment end 18 of the mounting strap 10 to the terminal end 22 of the mounting strap 10. More particularly, the first channel 40 is located adjacent to a first elongate edge 46 of the first strap half 26 and the second channel 42 is located adjacent to a second elongate edge 48 of the first strap half 26. As a result of this configuration, the track 44 is formed between the first channel 40 and the second channel 42. Stated another way, the track 44 is formed axially inboard of the first and second channels 40, 42 relative to the axial centerline A1 of the mounting strap 10.

Each cut resistant member 36, 38 is in the form of a chain, and in particular a Cuban link chain, comprising chain links (i.e., a plurality of interconnected members) linked together in series. In that regard, each cut resistant member may be considered a multi-body cut resistant member. When embedded within the mounting strap 10 between the first strap half 26 and the second strap half 28, the flexible configuration of each chain does not impair the flexibility of the mounting strap 10. This makes it easier for service providers to install the mounting strap 10 and monitoring device 12 on a wearer, as well as provides for a more comfortable and safer fit for the wearer. Further, each chain can be flexed repeatedly without the metal yielding and eventually breaking. The flattened nature of a chain alleviates pressure points within the mounting strap 10 and minimally impacts the mounting strap 10 thickness. Compared to other types of metal inserts, such as a metal strip or band, for example, the material weight of each chain is less, resulting in a more comfortable fit for the wearer. While the cut resistant members 36, 38 are shown and described as a chain, and in particular a Cuban chain, it is understood that other chain configurations could be used, such as a curb chain, double curb chain, or rope chain, for example. The chains may be formed from 304 stainless steel or other materials such as ASE 1006, for example. Further, it is understood that other cut-resistant member(s) may be used, such as hardened plastic, cable, or any other suitable structure that is flexible yet capable of resisting penetration of a sharpened object.

As briefly described above, in an alternative embodiment, the mounting strap 10 may include a single cut resistant member in the form of a chain, rather than two separate cut resistant member 36, 38. In this embodiment, the first and second channels 40, 42 may connect at the terminal end 22 of the mounting strap 10 to form a single, U-shaped channel. In that regard, the U-shaped channel may be similar to the U-shaped track 44, for example.

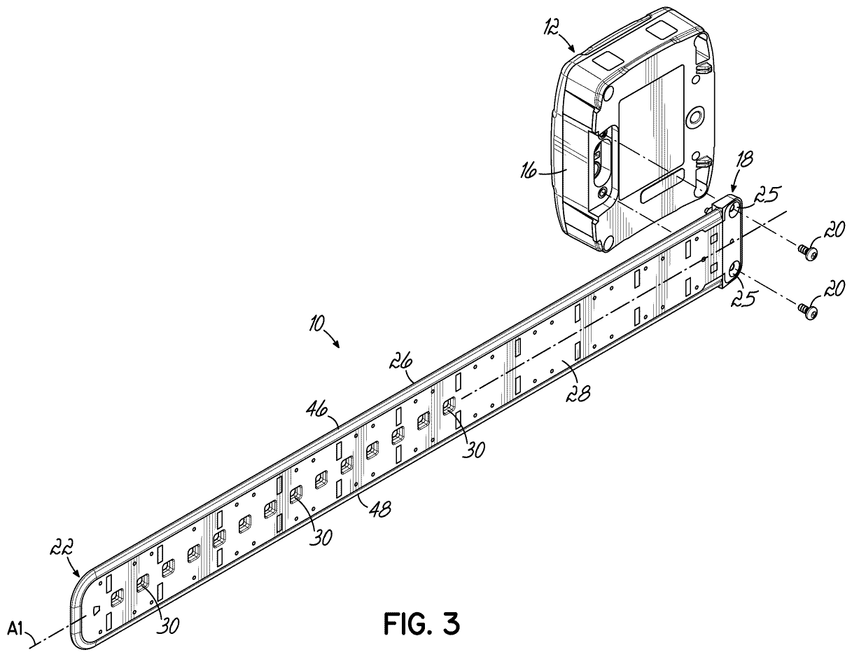

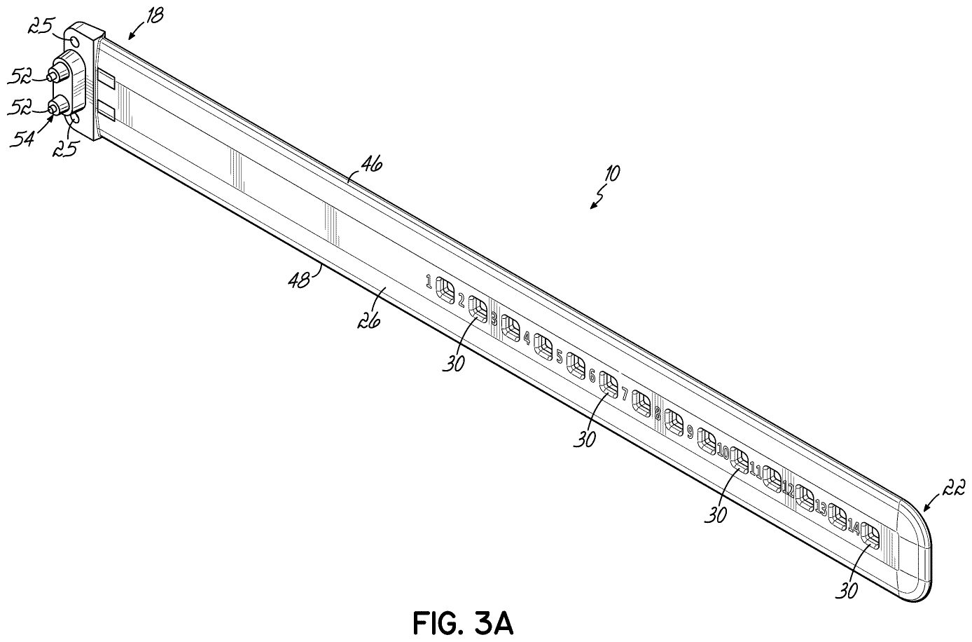

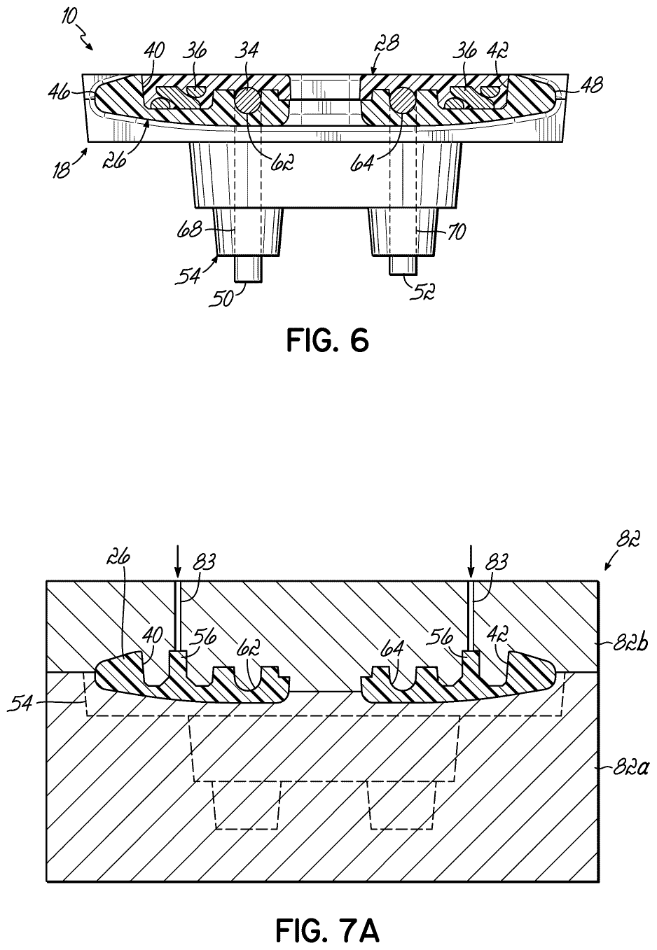

In one embodiment, the continuity element 34 is in the form of a fiber optic cord having a first terminal end 50 and a second terminal end 52, each of which is exposed from a terminal 54 at the attachment end 18 of the mounting strap 10, as shown in FIGS. 3A and 6. The terminal 54, and more particularly the first and second terminal ends 50, 52 of the continuity element 34 are configured to be connected to the electronics in the monitoring device 12 which can determine the integrity of the connections and the continuity element 34. Additionally or alternatively, the fiber optic cord 34 may function as a tamper alerting means. In that regard, should the continuity and integrity of the continuity element 34 be compromised as a result of tampering (e.g., severed), it is detected by the electronics and other circuitry in the monitoring device 12 and a corresponding alert condition is communicated wirelessly to a remote monitoring location and/or responsible authority. To this end, the continuity element 34 may be a wire or other cut-detectable member, for example. Further, the mounting strap 10 may include more continuity elements 34 embedded throughout its length. The mounting strap 10 may include a terminal cover 55 for protecting the terminal 54 and the exposed first and second terminal ends 50, 52 of the continuity element 34 during shipping, for example.

In another embodiment, the continuity element 34 may comprise a wire or other cut-detectable member. In particular, the continuity element 34 may comprise braided wire, stranded wire, sheet metal, or a combination thereof, or other similar conductive materials positioned between the first strap half 26 and the second strap half 28, such as within the first and second channels 40, 42. For example, the braided wire may be a single, unbroken length of braided wire positioned within the first and second channels 40, 42. Alternatively, two separate lengths of braided wire may be positioned within the first and second channels 40, 42 and electrically connected at the terminal end 22 of the mounting strap 10 with a U-shaped plate member, for example. In either case, the braided wire is connected to the electronics in the monitoring device 12 to create an electrical circuit that extends the length of the mounting strap 10. The resistance across the continuity element is then measured to determine if the circuit is complete or if there are any breaks or faults in the circuit. Should the integrity of the continuity element be compromised (e.g., a break or fault in the circuit) as a result of tampering, it is detected by the electronics and other circuitry in the monitoring device 12 and a corresponding alert condition is communicated wirelessly to a remote monitoring location and/or responsible authority.

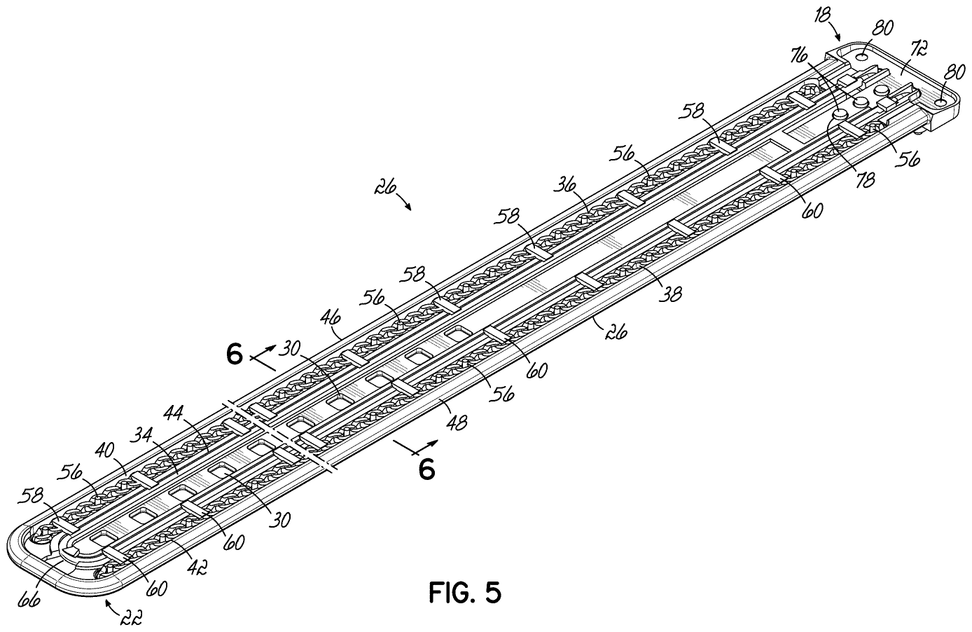

With reference to FIGS. 4-5, the first channel 40 includes a plurality of pegs 56 distributed along a length of the first channel 40 which are configured to maintain a position of the first cut resistant member 36 therein. Similarly, the second channel 42 includes a plurality of pegs 56 distributed along a length of the second channel 42 which are configured to maintain a position of the second cut resistant member 38 therein. Each of the plurality of pegs 56 is configured to be received through a respective chain link of each corresponding cut resistant member 36, 38, for example. The engagement between each peg 56 and the respective links of the chains 36, 38 prevents movement of each chain 36, 38, and in particular movement of each chain 36, 38 in the axial direction within the respective channel 40, 42.

The first strap half 26 further includes a first plurality of hold-downs 58 and a second plurality of hold-downs 60 each being distributed in a spaced apart arrangement along the length of the mounting strap 10. The first plurality of hold-downs 58 are located in a region of the first strap half 26 that is between the track 44 and the first channel 40 such that each of the first plurality of hold-downs 58 is configured to overlie a portion of the first channel 40 and a portion of the track 44. In that regard, the first plurality of hold-downs 58 maintain a position of the first cut resistant member 36 within the first channel 40 as well as maintain a position of the continuity element 34 within the track 44. Similarly, the second plurality of hold-downs 60 are located in a region of the first strap half 26 that is between the track 44 and the second channel 42 such that each of the second plurality of hold-downs 60 is configured to overlie a portion of the second channel 42 and a portion of the track 44. To this end, the second plurality of hold-downs 60 maintain a position of the second cut resistant member 38 within the second channel 42 as well as maintain a position of the continuity element 34 within the track 44.

With reference to FIGS. 5-6, the track 44 includes a first elongate portion 62 and a second elongate portion 64 that extend in parallel from the attachment end 18 of the mounting strap 10 to a U-shaped base portion 66 of the track 44 located at the terminal end 22 of the mounting strap 10. As best shown in FIG. 6, the first elongate portion 62 of the track 44 communicates with a first bore 68 formed in the first strap half 26 at the attachment end 18 and the second elongate portion 64 of the track 44 communicates with a second bore 70 formed in the first strap half 26 at the attachment end 18. As shown, the first and second bores 68, 70 extend through the terminal 54 with the first terminal end 50 of the continuity element 34 being routed through the first bore 68 and the second terminal end 52 of the continuity element 34 being routed through the second bore 70 to expose the terminal ends 50, 52 from the terminal 54.

With reference to FIGS. 4-5, the mounting strap 10 further includes a ground bracket 72 located between the first strap half 26 and the second strap half 28 at the attachment end 18 of the mounting strap 10. The ground bracket 72 may form part of a cellular antenna for a communications system of the monitoring device 12. Alternatively, the ground bracket 72 may facilitate the electrical connection between the continuity element 34 and the electronics in the monitoring device 12. In either case, the first strap half 26 includes an impression 74 at the attachment end 18 that corresponds to the generally T-shaped profile of the ground bracket 72. The impression 74 is formed with alignment pegs 76 configured to align and maintain a position of the ground bracket 72 within the impression 74. The ground bracket 72 includes a plurality of bores 78 configured to receive corresponding alignment pegs 76 therein. The ground bracket 72 further includes a pair of bores 80 each of which is configured to receive a respective fastener 20 therethrough. The pair of bores 80 are configured to align with mounting bores 25 such that, when the attachment end 18 of the mounting strap 10 is affixed to the monitoring device 12 with the fasteners 20, as shown in FIG. 3, the ground bracket 72 is in electrical communication with the pair of fasteners 20 and the monitoring device 12 to ground the mounting strap 10. In an alternative embodiment, electrical communication between the mounting strap 10 and the monitoring device 12 may be established using pogo pins or other suitable electrical connector, for example.

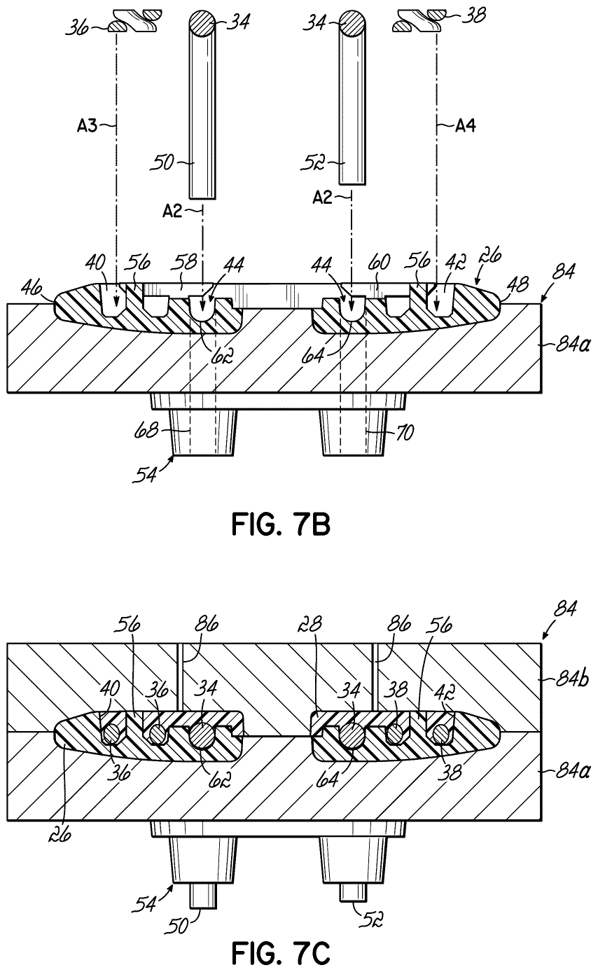

Referring now to FIGS. 7A-7C, a method of manufacturing the mounting strap 10 described above with respect to FIGS. 1-6 will now be described. In that regard, the method of manufacturing the mounting strap 10 may generally be referred to as overmolding, which is a type of injection molding. Thus, the mounting strap 10 may be formed by injection molding. However, other manufacturing techniques or processes may be used to form the mounting strap 10, such as two-shot injection molding, urethane casting, extrusion, compression molding, or other similar molding process, for example.

With reference to FIG. 7A-7C, a first mold tooling 82, otherwise referred to as an overmold, is provided having a first mold form 82a and a second mold form 82b. A first dose, or shot of a polymer material is injected into the first mold tooling 82 to form the first strap half 26, as shown. In that regard, the second mold form 82b may have one or more injection ports 83 for introducing the thermoplastic material into the mold 82. In another embodiment, the thermoplastic material may be dosed directly into the mold 82 before closing the mold forms 82a, 82b. As shown, the first strap half 26 is formed with the first channel 40, the second channel 42, and the track 44. In particular, the first strap half 26 is formed with the first and second plurality of hold-downs 58, 60, and each channel 40, 42 is formed with respective pegs 56.

Once the first strap half 26 has been formed, the first strap half 26 is moved to a second mold tooling 84 having a first mold form 84a and a second mold form 84b. The first strap half 26 is placed in the first mold form 84a and the continuity element 34, cut resistant members 36, 38, and ground bracket 72 may be positioned within the first strap half 26. In that regard, the ground bracket 72 is disposed within the impression 74, as shown in FIG. 5, for example. The continuity element 34 is disposed within the track 44, as indicated by directional arrows A2 in FIG. 7B. The first cut resistant member 36 is also disposed within the first channel 40, as indicated by directional arrow A3, and the second cut resistant member 38 is disposed within the second channel 42, as indicated by directional arrow A4. Once the components 34, 36, 38, 72 have been disposed within the first strap half 26 (e.g., FIG. 5), the mold 84 is closed and a second dose, or shot of a polymer material is injected into the mold 84 via injection ports 86 formed in the second mold form 84b to thereby form the second strap half 28 over the first strap half 26. In another embodiment, the thermoplastic material may be dosed directly into the mold 84 before closing the mold forms 84a, 84b. To this end, the first strap half 26 and the second strap half 28 are formed together as a unitary piece.

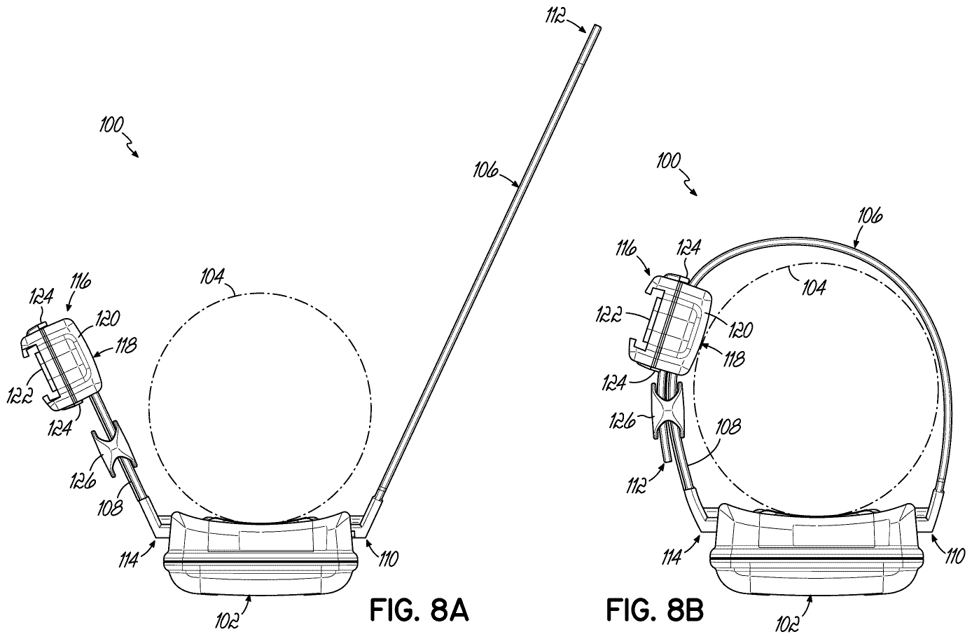

Referring now to FIGS. 8A-8B, a mounting strap assembly 100 for securing a monitoring device 102 to an object 104, such as a person's ankle or wrist, for example, is shown in accordance with another embodiment of the invention. In that regard, like reference numerals represent like features compared to the embodiment described above with respect to FIGS. 1-7C. The primary difference between the mounting strap assembly 100 of this embodiment and the mounting strap 10 of the previously described embodiment is that the mounting strap assembly 100 includes a first strap portion 106 and a second strap portion 108 that are configured to be wrapped around the object 104 and connected together to secure the monitoring device 102 to the object 104 (e.g., FIG. 8B). That is, the mounting strap assembly 100 of this embodiment is a two strap configuration rather than a single strap configuration.

With continued reference to FIGS. 8A-8B, the first strap portion 106 is elongate and extends from an attachment end 110 configured to be affixed to the monitoring device 102, such as with fasteners, to a terminal end 112 configured to be selectively coupled to the second strap portion 108, as described in further detail below. While not shown, the first strap portion 106 may be similar to the mounting strap 10 described above with respect to FIGS. 1-7C in that it includes a first elongate strap half 26 and a second elongate strap half 28 molded together to form the first strap portion 106, being a uniform piece. Furthermore, the first strap portion 106 includes a continuity element 34 and at least one cut resistant member 36, 38 located between the first strap half 26 and the second strap half 28.

Like the first strap portion 106, the second strap portion 108 is elongate and extends from an attachment end 114 configured to be affixed to the monitoring device 102, such as with fasteners, to a terminal end 116. The second strap portion 108 may be shorter in length compared to the first strap portion 106. As shown, the terminal end 116 of the second strap portion 108 includes a clasp or buckle 118 configured to join the ends 112, 116 of the first and second strap portions 106, 108 together, as will be described in further detail below. While not shown, the second strap portion 108 may be similar to the mounting strap 10 described above with respect to FIGS. 1-7C in that it includes a first elongate strap half 26 and a second elongate strap half 28 molded together to form the second strap portion 108, being a uniform piece. Furthermore, the second strap portion 108 includes a continuity element 34 and at least one cut resistant member 36, 38 located between the first strap half 26 and the second strap half 28. It is noted that a length of certain components may be varied to achieve the desired length of the second strap portion 108.

With continued reference to FIGS. 8A-8B, the buckle 118 includes base 120 and a removable latch 122 that interlocks with the base 120 to secure the first strap portion 106 to the second strap portion 108. In that regard, the latch 122 may include one or more locking pins or teeth 124 configured to engage one or more of the plurality of adjustment holes 30 formed in the first strap portion 106 to secure and maintain a fit of the mounting strap assembly 100 about the person's ankle or wrist 104, for example. As best shown in FIG. 8B, the first strap portion 106 is wrapped around the object 104, and the terminal end 112 of the first strap portion 106 is then passed through the buckle 118 to secure the monitoring device 102 to the object 104. In particular, the first strap portion 106 is passed through an opening between the body 120 and latch 122 of the buckle 118, and the latch 122 clamped down over the first strap portion 106 to secure the first strap portion 106 to the second strap portion 108, as shown. As a result, a length of the first strap portion 106 extends through the buckle 118 to overlie part of the second strap portion 108. The second strap portion 108 further includes a retainer 126 to manage the length of the first strap portion 106 that extends through the buckle 118. In particular, the retainer 126 is a ring or loop located on the second strap portion 108 that is used to secure the loose terminal end 112 of the first strap portion 106 after it has been received through the buckle 118. That is, the retainer 126 holds the loose terminal end 112 of the first strap portion 106 in place against the second strap portion 108.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1-42. (canceled)

43. A mounting strap for securing a monitoring device to a part of a person, the monitoring device having a housing containing components of the monitoring device and a locking mechanism configured to engage the mounting strap, the mounting strap comprising:
a first strap half and a second strap half, each strap half extending between an attachment end of the mounting strap and a terminal end of the mounting strap to define an elongate length of the mounting strap;
a continuity element located between the first strap half and the second strap half; and
a multi-body cut resistant member located between the first strap half and the second strap half;
wherein the mounting strap is affixed to the housing of the monitoring device with the attachment end of the mounting strap.

44. The mounting strap of claim 43, wherein the multi-body cut resistant member is located between a lengthwise edge of the mounting strap and the continuity element.

45. The mounting strap of claim 43, wherein the multi-body cut resistant member comprises a first multi-body cut resistant member and a second multi-body cut resistant member.

46. The mounting strap of claim 45, wherein the first strap half includes a first channel configured to receive the first multi-body cut resistant member therein and a second channel configured to receive the second multi-body cut resistant member therein.

47. The mounting strap of claim 46, wherein the first channel and the second channel extend in parallel from the attachment end of the mounting strap to the terminal end of the mounting strap.

48. The mounting strap of claim 47, wherein the first channel includes a plurality of pegs configured to maintain a position of the first multi-body cut resistant member therein and the second channel includes a plurality of pegs configured to maintain a position of the second multi-body cut resistant member therein.

49. The mounting strap of claim 46, wherein the first strap half includes a track configured to receive the continuity element therein.

50. The mounting strap of claim 49, wherein the track includes a first elongate portion and a second elongate portion that extend in parallel from the attachment end of the mounting strap to a U-shaped base portion at the terminal end of the mounting strap.

51. The mounting strap of claim 50, wherein the first elongate portion of the track communicates with a first bore formed in the first strap half at the attachment end and the second elongate portion of the track communicates with a second bore formed in the first strap half at the attachment end.

52. The mounting strap of claim 51, wherein a first terminal end of the continuity element is routed through the first bore and a second terminal end of the continuity element is routed through the second bore.

53. The mounting strap of claim 49, wherein the track is located between the first channel and the second channel.

54. The mounting strap of claim 46, wherein the first strap half includes a first plurality of hold-downs distributed along the length of the mounting strap that are configured to overlie the first channel and a second plurality of hold-downs distributed along the length of the mounting strap that are configured to overlie the second channel.

55. The mounting strap of claim 50, wherein the first strap half includes a first plurality of hold-downs distributed along the length of the mounting strap that are configured to overlie the first channel and the first elongate portion of the track, and a second plurality of hold-downs distributed along the length of the mounting strap that are configured to overlie the second channel and the second elongate portion the track.

56. The mounting strap of claim 43, further comprising a ground bracket located between the first strap half and the second strap half at the attachment end of the mounting strap.

57. The mounting strap of claim 56, wherein the ground bracket is in electrical communication with a pair of fasteners used to affix the mounting strap to the monitoring device.

58. The mounting strap of claim 43, wherein the multi-body cut resistant member comprises a chain.

59. The mounting strap of claim 43, wherein the continuity element comprises a fiber optic cord.

60. A monitoring device, comprising:
a housing enclosing electronic components of the monitoring device and a locking mechanism; and
a mounting strap according to claim 43, the attachment end being affixed to the housing and the terminal end configured to be selectively coupled to the housing of the monitoring device with the locking mechanism.

61. The monitoring device of claim 60, further comprising a plurality of adjustment holes formed in the first strap half and the second strap half and distributed along the length of the mounting strap, the plurality of adjustment holes configured to receive a portion of the locking mechanism of the monitoring device to selectively couple the terminal end of the mounting strap to the housing.

62. A method of manufacturing the mounting strap of claim 43, comprising:
providing a first mold;
disposing a first shot of polymer material therein;
forming the first strap half from the first shot of polymer material, the first strap half having a first channel, a second channel, and a track formed therein, each of which extend from the attachment end of the mounting strap to the terminal end of the mounting strap;
providing a second mold and disposing the first strap half in the second mold;
disposing the continuity element within the track;
disposing the multi-body cut resistant member within the first or second channel;
disposing a second shot of polymer material in the second mold; and
forming the second strap half over the first strap half such that the first strap half and the second strap half are formed together as a unitary piece.
